(19) United States
(12) Patent Application Publication
(10) Pub. No.: US 2003/0050531 A1
(43) Pub. Date: Mar. 13, 2003

(54) Medico-surgical devices

(76) Inventor: Stephen James Field, Canterbury (GB)

Correspondence Address: LOUIS WOO, LAW OFFICE OF LOUIS WOO, 717 NORTH FAYETTE STREET, ALEXANDRIA, VA, 22314, US

(21) Appl. No.: 10/233,485

(22) Filed: Sep. 4, 2002

(30) Foreign Application Priority Data
Sep. 8, 2001 (GB) 0121690.2

(51) Int. Cl. A61D 7/00

(52) U.S. Cl. 600/34

(57) ABSTRACT

An embryo transfer catheter has a main lumen, which opens close to the patient end through a side opening. The catheter is extruded with a second, smaller lumen, which is closed at both ends. The second lumen is filled with air so that it reflects ultrasound energy and enhances the visibility of the catheter under ultrasound observation.

### BACKGROUND OF THE INVENTION

This invention relates to medico-surgical devices.

The invention is more particularly concerned with medico-surgical devices, such as catheters, that are visible under ultrasound observation.

Ultrasound imaging equipment is increasingly being used during surgical procedures to monitor the location of a device within the body. The visibility of a device under ultrasound depends on various factors including the difference between the acoustic impedance of the material of the device and that of the surrounding medium, such as the patient tissue or body fluid within which the device is located. This difference is relatively low with plastic devices, such as catheters, making conventional catheters difficult to locate.

Attempts have been made to increase the visibility of medico-surgical devices under ultrasound observation in various ways. The surface of the device may be modified, such as by forming grooves or indentations in its surface. A reflective coating may be applied to the device, such as incorporating bubbles, as described in WO98/19713 and EP0624342. Alternatively, a metal marker may be secured to a plastics catheter.

### BRIEF SUMMARY OF THE INVENTION

It is an object of the present invention to provide an alternative medico-surgical device.

According to one aspect of the present invention there is provided a medico-surgical device including a shaft of tubular form having a first lumen extending along the device for use in conveying material along the device and a second lumen closed at least at one end and without opening therefrom along its length so as to enclose a volume of gas such that the interface with the gas in the second lumen enhances ultrasound reflection from the device.

According to another aspect of the present invention there is provided an embryo transfer catheter device including a shaft having a first lumen for use in transferring an embryo and a second lumen closed at least at the patient end so as to enclose a volume of gas such that the interface with the gas in the second lumen enhances ultrasound reflection from the device.

The embryo catheter device may include an outer sheath along which the shaft is slidable. The second lumen is preferably closed at both ends and the second lumen preferably has a smaller cross-section than the first lumen. The second lumen may be continuous between its ends or it may be intermittent along its length, having a plurality of gas-filled sections. The second lumen may have a circular cross-section or it may be D-shape in section. The first and second lumens are preferably extruded. The first lumen may open towards the patient end of the device on the side of the device. The external surface of the device is preferably smooth. The device may include a plurality of second lumens.

According to a third aspect of the present invention there is provided a method of monitoring an embryo transfer catheter including the steps of providing an embryo transfer catheter having a first lumen for use in transferring an embryo and a second, smaller lumen filled with gas and closed towards the patient end of the catheter, and viewing the catheter with ultrasound scanning apparatus so that ultrasound energy is reflected from the interface with gas in the second lumen.

An embryo-transfer catheter according to the present invention, will now be described, by way of example, with reference to the accompanying drawings.

### BRIEF DESCRIPTION OF THE DRAWINGS

FIG. 1 is a side elevation view of the catheter;

FIG. 2 is a sectional side elevation view of the patient end of the catheter of FIG. 1 to a larger scale;

FIG. 3 is a sectional transverse view through the catheter along the line III-III;

FIG. 4 is a sectional transverse view through an alternative catheter; and

FIG. 5 is a sectional transverse view through another alternative catheter.

### DETAILED DESCRIPTION OF THE PREFERRED EMBODIMENTS

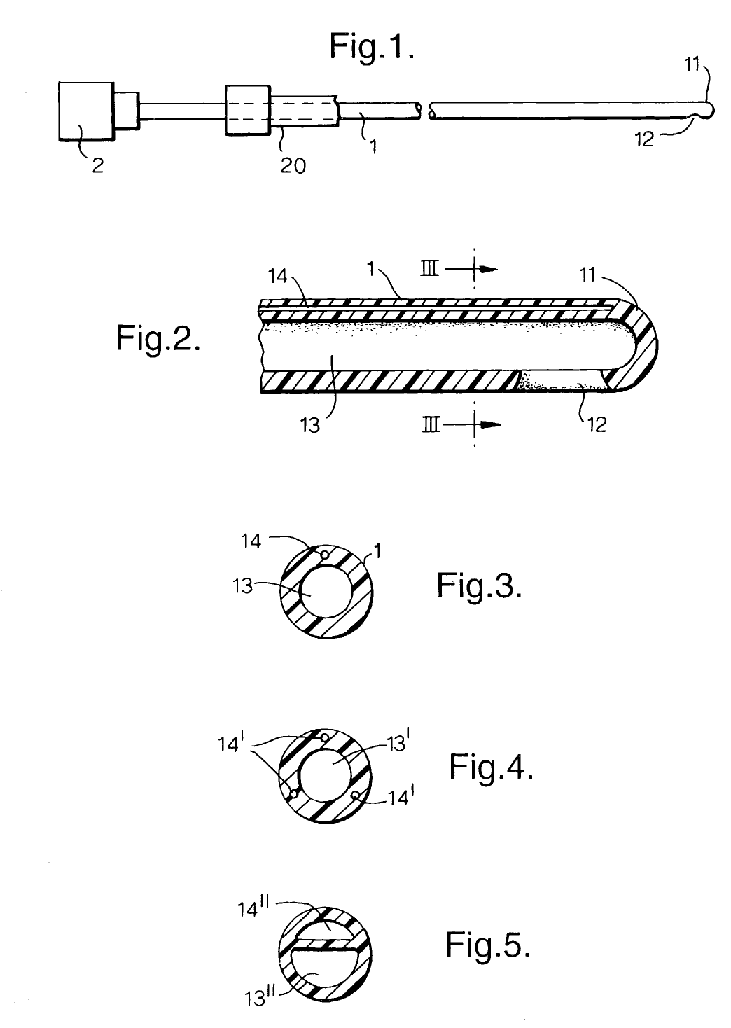

With reference first to FIGS. 1 to 3, the catheter comprises an extruded flexible shaft 1 of a clear, transparent polyurethane and a hub 2 of polypropylene joined at the rear end of the shaft. The shaft 1 is between about 180 mm and 380 mm long with a circular section, an outer diameter of 1.6 mm and an inner diameter of 1.1 mm. The forward, right-hand, patient end 11 of the catheter is atraumatically rounded and there is a side opening 12 close to the end.

The catheter has two lumens extending along its length. The main lumen 13, through which an embryo is transfer along the catheter and out of the opening 12, is of circular shape and occupies the major part of the cross-section. The lumen 13 opens at one end into the hub 2 and opens at its other end through the opening 12. The other, minor lumen 14 extends parallel to the main lumen 13 within the wall of the catheter. The minor lumen 14 is of circular section, although it could be of other shapes, such as crescent shape, and is smaller in cross-section than the main lumen 13. The minor lumen 14 is closed at both ends and is filled with air or some other gas.

In use, the main lumen 13 is normally filled with a liquid in which the embryo is bathed, so the acoustic properties of this lumen are similar to that of the uterus and there is, therefore, very little reflection of ultrasonic energy from this part of the catheter. The air-filled minor lumen 14, however, reflects considerably more acoustic energy because there is a large difference between acoustic transmission properties of air and of both the plastic of the catheter and the liquid surrounding the catheter in the uterus.

The minor lumen 14 is preferably as small as is compatible with providing a visible ultrasound image, in order to allow for the maximum size of the main lumen 13.

The minor lumen 14 need not be closed at both ends providing that the minor lumen does not fill with liquid. The minor, gas-filled lumen could be intermittent along the length of the catheter with separate gas-filled sections. It will be appreciated that the catheter could have more than one gas-filled lumen, such as, for example shown in FIG. 4 where the catheter has three gas-filled lumens 14′. Where a larger gas-filled lumen 14″ is needed, it may have a D-shape section, as shown in FIG. 5.

The catheter may be provided as a combination device or assembly with an outer sheath 20 (only a part of which is shown in FIG. 1) used to give extra stiffness during insertion. A combination device of an embryo transfer catheter and an outer sheath is described in greater detail in GB 2209673.

Because the catheter does not require any coating or separate marker, there is no need for subsequent assembly operations and there is no risk of detachment. The catheter can be made of conventional medically-approved materials so does not present any new risk to the patient. Because the outer surface of the catheter can be smooth, the catheter can be inserted or slid through an outer sheath with low friction. The smooth bore of the catheter ensures free flow along the bore, which can be important where the catheter is used to transfer embryos. The smooth surfaces also reduce the accumulation of biofilm on the catheter. The catheter can be made without the need for metal components, which can be an advantage where the catheter is used while the patient is being viewed by magnetic imaging techniques. The catheter can be completely transparent to x-rays or the plastics from which it is formed could incorporate an x-ray opaque filler, such as barium sulphate.

What I claim is:

1. A medico-surgical device comprising a shaft of tubular form, said shaft having a first lumen extending along it for use in conveying material along said shaft and a second lumen closed at least at one end and without opening therefrom along its length so as to enclose a volume of gas such that an interface with said gas in said second lumen enhances ultrasound reflection from said device.

2. A device according to claim 1, wherein said second lumen is closed at both ends.

3. A device according to claim 1, wherein said second lumen has a smaller cross-section than said first lumen.

4. A device according to claim 1, wherein said second lumen is closed at both ends.

5. A device according to claim 1, wherein said second lumen is continuous between its ends.

6. A device according to claim 1, wherein said second lumen is intermittent along its length, having a plurality of gas-filled sections.

7. A device according to claim 1, wherein said second lumen has a circular cross-section.

8. A device according to claim 1, wherein said second lumen is D-shape in section.

9. A device according to claim 1, wherein said first and second lumens are extruded

10. A device according to claim 1, wherein said first lumen opens on a side of the device towards a patient end of the device.

11. A device according to claim 1, wherein an external surface of said device is smooth.

12. A device according to claim 1, including a plurality of said second lumens.

13. An embryo transfer catheter device comprising a shaft, said shaft having a first lumen for use in transferring an embryo, and a second lumen closed at least at a patient end of said shaft so as to enclose a volume of gas such that an interface with said gas in said second lumen enhances ultrasound reflection from the device.

14. An embryo transfer catheter device according to claim 13 including an outer sheath along which said shaft is slidable.

15. A method of monitoring an embryo transfer catheter comprising the steps of providing an embryo transfer catheter having a first lumen for use in transferring an embryo and a second, smaller lumen filled with gas and closed towards a patient end of said catheter; and viewing said catheter with ultrasound scanning apparatus so that ultrasound energy is reflected from an interface with gas in said second lumen.

16. An embryo transfer catheter comprising: a hub at a machine end, and a flexible, extruded shaft of a plastics material extending from said hub, said shaft including: a first lumen for use in transferring an embryo, said first lumen having an opening towards a patient end of said shaft; a second lumen, said second lumen being extruded within a wall of said shaft and having a smaller cross-section than said first lumen, and said second lumen being closed along its length from its patient end so as to enclose a volume of gas in said second lumen that provides an interface that enhances ultrasound reflection from the catheter.

17. An embryo transfer catheter device comprising: an outer sheath and a catheter slidable along said outer sheath, wherein said catheter comprises: a hub at a machine end, and a flexible, extruded shaft of a plastics material extending from said hub, said shaft including: a first lumen for use in transferring an embryo, said first lumen having an opening towards a patient end of said shaft; a second lumen, said second lumen being extruded within a wall of said shaft and having a smaller cross-section than said first lumen, and said second lumen being closed along its length from its patient end so as to enclose a volume of gas in said second lumen that provides an interface that enhances ultrasound reflection from the device.
